(19) United States
(12) Patent Application Publication
(10) Pub. No.: US 2017/0206613 A1
(43) Pub. Date: Jul. 20, 2017

(54) SYSTEMS AND METHODS FOR FLEXIBLE FOLLOW SEMANTICS FOR BUSINESS OBJECTS

(71) Applicant: salesforce.com, inc., San Francisco, CA (US)

(72) Inventor: Gary HOREN, Seattle, WA (US)

(73) Assignee: salesforce.com, inc., SAN FRANCISCO, CA (US)

(21) Appl. No.: 15/000,982

(22) Filed: Jan. 19, 2016

(51) Int. Cl. G06Q 50/00; H04L 29/06; H04L 29/08

(52) U.S. Cl. CPC G06Q 50/01; H04L 67/1095; H04L 65/4076

(57) ABSTRACT

The technology disclosed describes systems and methods for generating and utilizing flexible follow semantics for business objects in an enterprise social network—efficiently optimizing the follow semantics for the business objects using follow-models designed to optimize feeds for relevance and usefulness, in a multi-tenant environment. The technology disclosed further relates to managing digital data for a plurality of tenants to software instances, each tenant of the plurality of tenants comprising a group of users who share a common access with a specific set of privileges to a software instance of at least one application. The technology discloses systems and methods for flexible follow semantics for business objects in a large, distributed service center operation.

### FIELD OF DISCLOSURE

The technology disclosed describes systems and methods for applying flexible follow semantics for business objects in an enterprise social network—efficiently optimizing the follow semantics for the business objects using follow-models designed to optimize news-feeds for relevance and usefulness, in a multi-tenant environment. The methods disclosed include managing digital data for a plurality of tenants to software instances, each tenant of the plurality of tenants comprising a group of users who share a common access with a specific set of privileges to a software instance of at least one application.

The technology discloses systems and methods for applying flexible follow semantics for business objects used for a large, distributed service center operation. Multiple follow-models with different follow semantics can be defined for different entities when the business objects are developed.

### INTRODUCTION

Historically companies have included the use of customers' news-feeds for communication, applying the concept that users could collaborate around standard business objects. Viewers could specify a feed by subscribing to a collection of business objects. Examples of business objects include a customer account of interest or a client-initiated support request, which is commonly referred to as a case. The business object would have a ‘wall’ and users could follow and read posts (feed-items) by anyone to the wall for the account of interest. Following an object meant following the object's wall—seeing everything posted, much like following a ‘friend’ in a social network and seeing everything posted to the friend's wall. In this context, the content can be overly broad, so this all-inclusive follow model has limited usefulness.

A different follow model can be useful for discovering what is going on in an organization, for discovering ways in which a specific user is successful, and for understanding the working structure of the organization. When the viewer follows a user, they follow the posts that the user makes wherever they are placed, but not posts that are made to the user's wall by others. Using this follow model, viewers would also see posts made to groups that refer to the user of interest, and would not need to wade through unrelated posts. This is similar to a social network in which a viewer sees comments added to items in a feed on their wall without seeing unrelated posts initiated by other users who are not ‘friends’. In summary, the concept of a feed that shows everything posted to a wall is separate from the concept of following posts for a specific business object.

Relevance and usefulness are two of the most important features for business object feeds used by enterprise social networks and large service organizations. Different companies have distinct needs, motivating the need for client-specific follow-models. The disclosed technology makes it possible to deliver flexible follow semantics for optimizing business object feeds to provide relevant, useful data.

An opportunity arises to improve the news-feed experience for customers and for workers by applying flexible follow semantics for different types of business objects, to organize feed-item selection and feed presentation to transmit for display when a customer or worker requests a view of their respective news-feeds.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 illustrates one example implementation of an enterprise social network environment for selecting follow-models.

FIG. 2 shows an example relationship between a follower and their subscriptions and the objects and users they follow.

FIG. 3A illustrates a feed follow user interface example, including posting to an account business object.

FIG. 3B illustrates a feed follow user interface example of a following feed on an account “wall”.

FIG. 4A shows an example user interface showing active groups that can be joined, to follow.

FIG. 4B shows an example user interface showing a post to a business object, with an @mention.

FIG. 5 shows an example business object post in a group feed due to an @mention.

FIG. 6A shows an example user interface showing selection of a user to follow.

FIG. 6B shows an example user interface showing selection for viewing a user post to a group.

FIG. 7 shows an example workflow for accessing a viewer's subscriptions and applying flexible follow-models to organize and display news-feeds.

FIG. 8 is a block diagram of an example computer system for implementing an environment for accessing flexible follow semantics for business objects.

FIG. 9 shows an example of a follower's news feed.

The disclosed systems and methods for flexible follow semantics for business objects are described in detail below. Multiple follow-models with different follow semantics can be defined for entities when the business objects are developed.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

A news-feed is a composed application output whose goal is to display content of interest to the follower of the news-feed. A new problem of incomprehensibility in news-feeds has been encountered due to the emerging demands of customers for “instantaneous” service and the presence of near-continuous input streams. A system developer of entities needs to have available a library of follow-models, to make it possible to select among models when customizing the follow semantics for a new business object.

Existing enterprise social network models, such as Salesforce Chatter, include the concept that an entity can host an arbitrary number of conversations that pertain to it. A conversation begins with the posting of a feed-item, and the conversation continues in comments appended to the initial post. This is a good fit for collaboration activity that happens in a group organized around multiple matters on an entity, such as an account that includes a number of separate collaboration activities active at the same time. This type of feed is a collection of separate conversations from the viewpoint of the participants.

When an entity that represents a single conversation, e.g. case, hosts multiple conversations concurrently, the resulting feed can be confusing. For example, many marketing managers monitor multiple accounts and opportunities on an ongoing basis. Confusion can happen, for example, when the feed for an entity is to be used in the process of solving a finite, time critical problem, so the people who are collaborating need to be able to view a single, time-ordered thread to ascertain a quick understanding of the current state of the problem and to reach agreement on the next steps to take to solve the problem. In this situation, the inclusion of multiple conversations on a single feed entity becomes disruptive.

Historically, the experience in these types of enterprise social network entities has been a single-threaded continuous stream of time-ordered comments.

Creating a new follow model for the case entity is one way of solving this problem: an agent reading the feed can see internal collaboration on each of the customer's responses in his feed, but the customer will only see his conversation with the service as a whole (in a rolled up, time ordered sequence of posts). This makes it possible for the agent to pull in assistance (by “@mentioning” experts) to address each customer concern, but lets the customer see a simplified view in his feed, which more accurately represents his understanding of the exchange between him and the service.

In summary, the disclosed technology utilizes flexible follow semantics for creating sensible news-feeds that present relevant and useful feed-items to followers, including accessing a plurality of follow-models that define feed content and presentation. Developers receive input selecting a follow-model to apply to an object entity or container entity being followed; and apply the selected follow-models to organize item selection and feed presentation to transmit for display when followers request a view of their respective news-feeds. Follow semantics for a follow-model are rooted to an object entity or a container entity; and a follower's news-feed is populated by items specified by follow-models applied to object entities and/or container entities being followed. The presentation of the items in the follower's news-feed is determined by the follow-models applied; and the follow-models are differentiated by definition in the follow-models of items to select based on the object entities and/or container entities being followed; ordering and/or grouping of the items; and the outline structure and/or appearance of structured sequences of the items. An example environment for implementing flexible follow semantics is described next.

### Environment

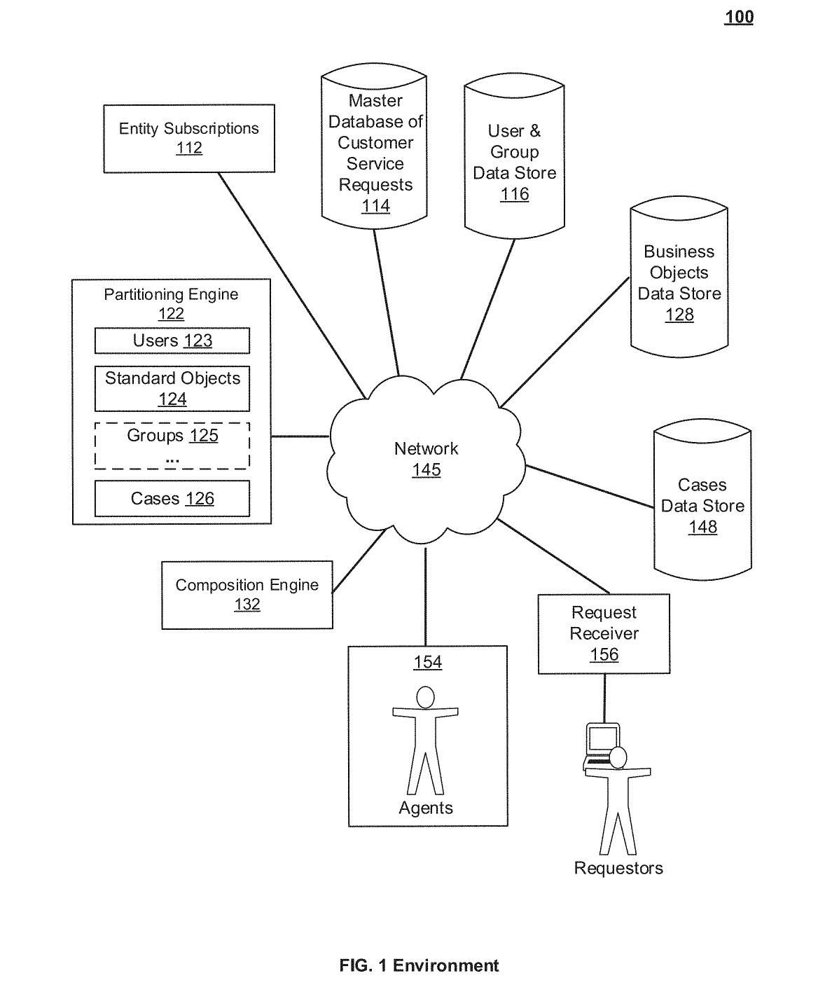

FIG. 1 illustrates an example enterprise social network environment 100 that includes flexible follow semantics for business objects, which includes entity subscriptions 112, a partitioning engine 122, and a composition engine 132. In some implementations, agents 154 respond to customer feedback—problems and questions captured via request receiver 156—stored in a master database of customer service requests 114. User and group data store 116 includes identifiers for the users of the enterprise social network and for the groups within the set of users of the network. Business objects data store 128 includes objects that can be followed; that is, objects that support a feed. In one example, account includes a feed-item identifier for tracked changes and for comments added to the account. Additional standard objects that can include feeds are assets, cases, contacts, contracts, leads, opportunities, quotes, and users. Cases data store 148 includes client-related communication records, as well as intermediate internal feed-items that capture problem-solving steps.

Partitioning engine 122 separates subscriptions according to follow semantics, and passes them to the composition engine 132 for further processing—separating incoming feed-item data into buckets by follow semantics. A feed-item can be an entry in the news-feed, such as a change to a record that is being followed, an updated post, or a user status change. In one example, a set of containers includes users 123, standard objects 124, optionally groups 125 and cases 126. Each of the containers can hold data for the entity subscriptions 112.

Composition engine 132 can generate the news-feed for a follower using one of two mechanisms: either by completing a set of subqueries that pull together a news-feed from various business objects, each governed by its corresponding follow-model; or by fanning feed-items out to per-subscriber collections (i.e. a materialized view of each subscriber's news-feed) as the feed-items are received in the enterprise system.

In other implementations, environment 100 may not have the same elements as those listed above and/or may have other/different elements instead of, or in addition to, those listed above.

### Follow-Models

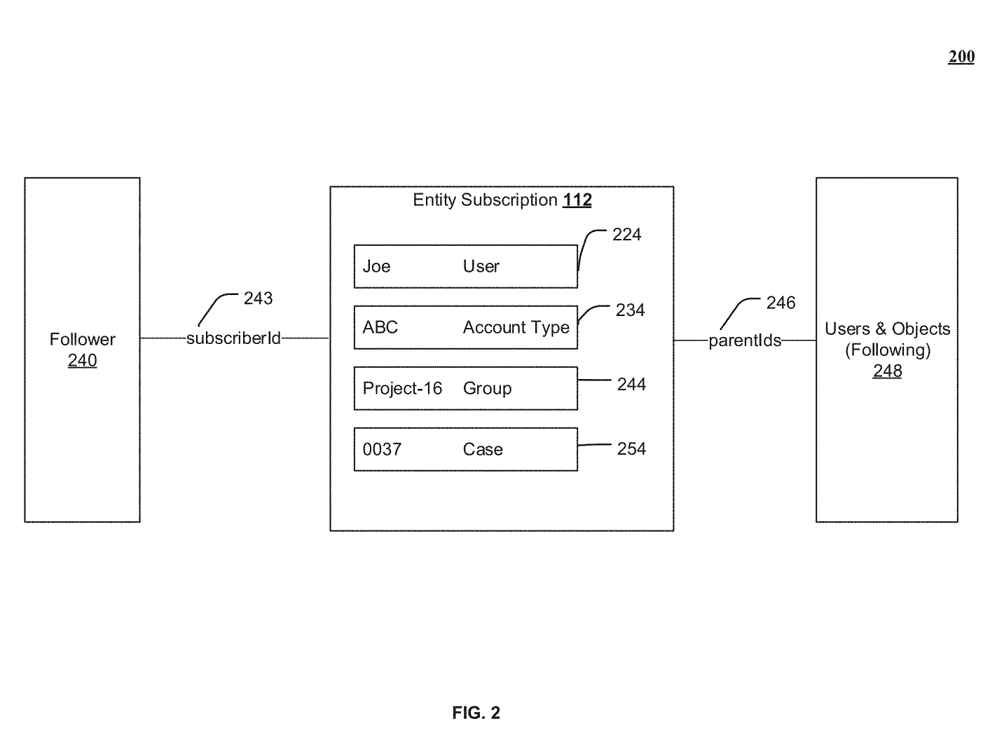

Each user in the enterprise social network environment has a news-feed that includes a subscription to the business objects they choose to follow. FIG. 2 shows an example set of business object choices in a table of entity subscription 112 for one follower 240, who follows these business objects: user Joe 224, account ABC 234, group Project-16 244, and customer 0037 254. SubscriberID 243 is the identity of the follower 240 of the record(s) and user(s). Feed-items include a parentID 246 which identifies the record that has been changed or the “followed” user who received a feed post.

For the disclosed technology, a follow-model can be specified when an entity is defined. Follow models, in general, cause artifacts to appear in a follower's news-feed. In some implementations of follow-models, a follower can optionally mute the feed for a business object or group they are following, to lessen the number of feed-items in their news-feed. That is, an adjustable follow model can include the option of allowing the user to adjust his feed to adapt the volume of feed-items received by a user of the system, and can specify object visibility and inclusion in news-feeds.

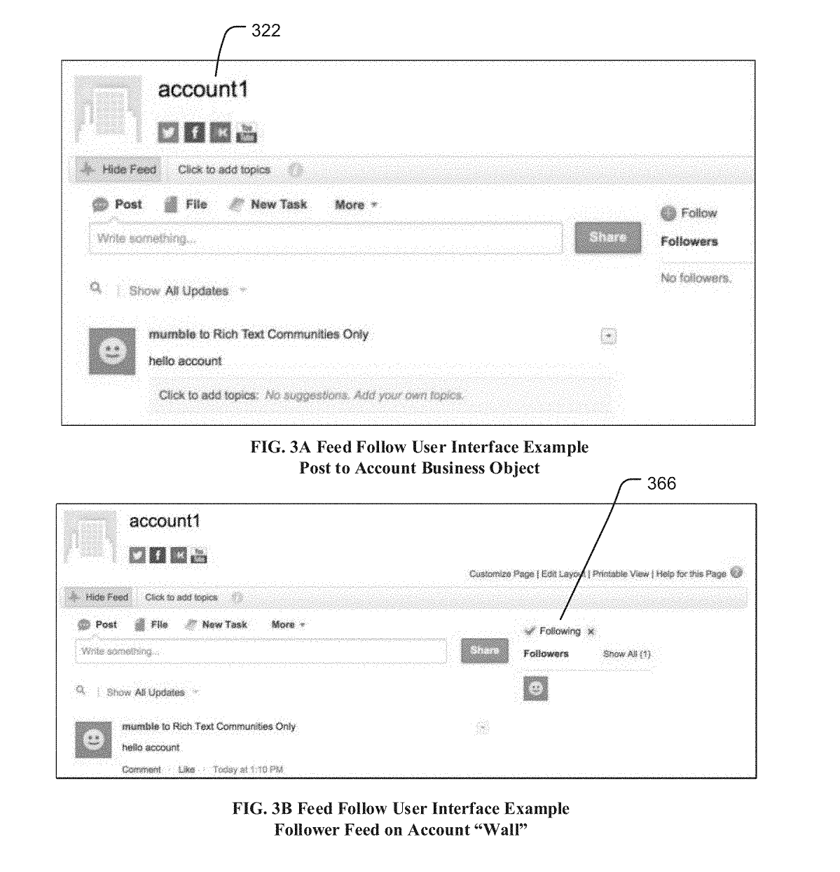

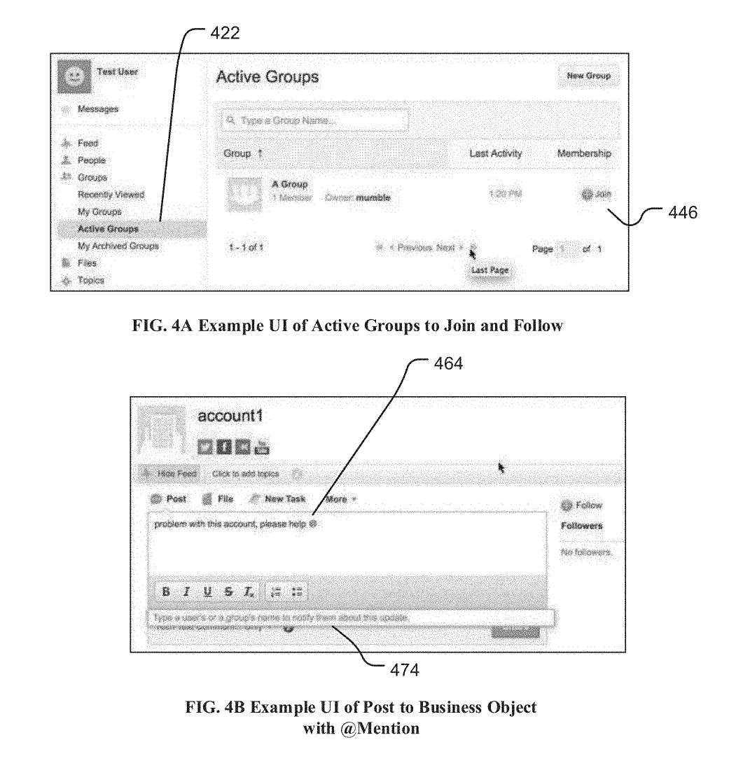

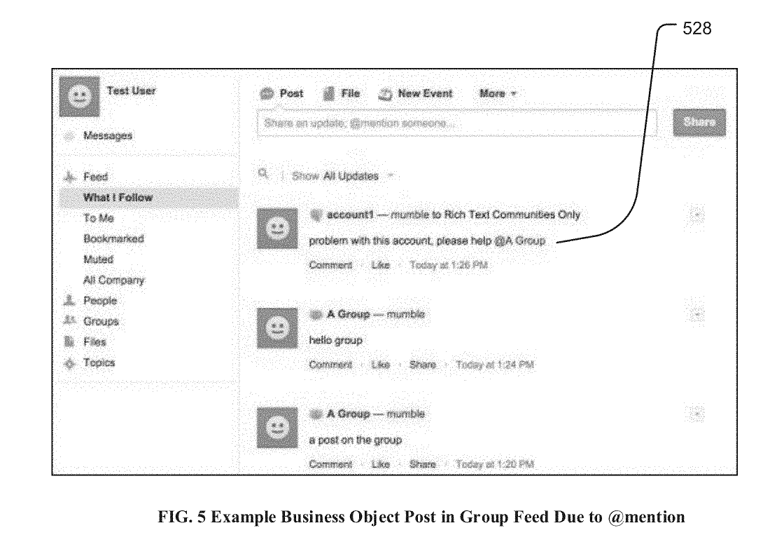

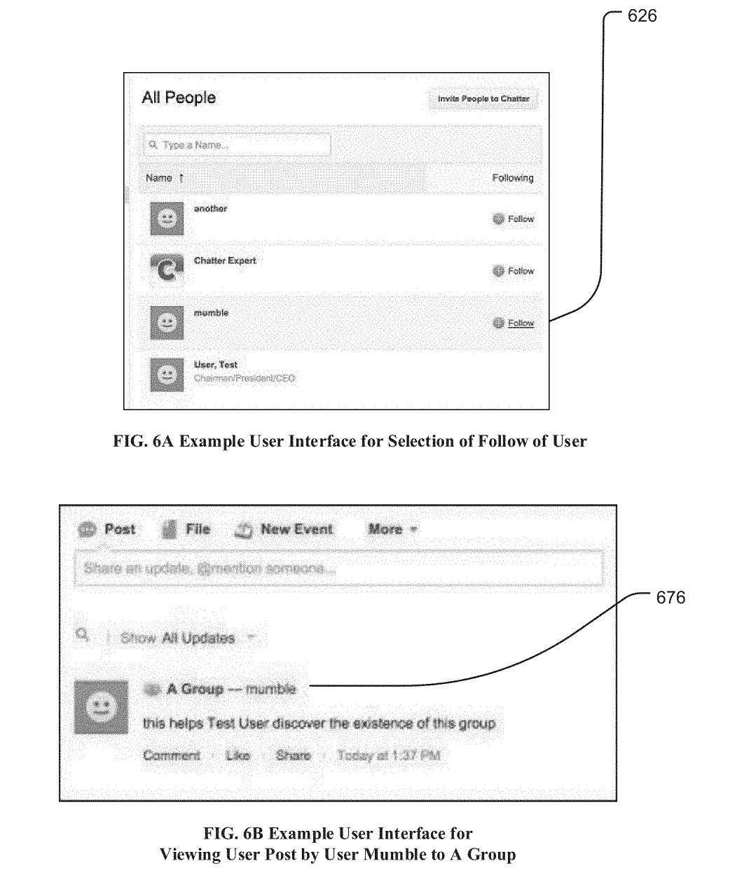

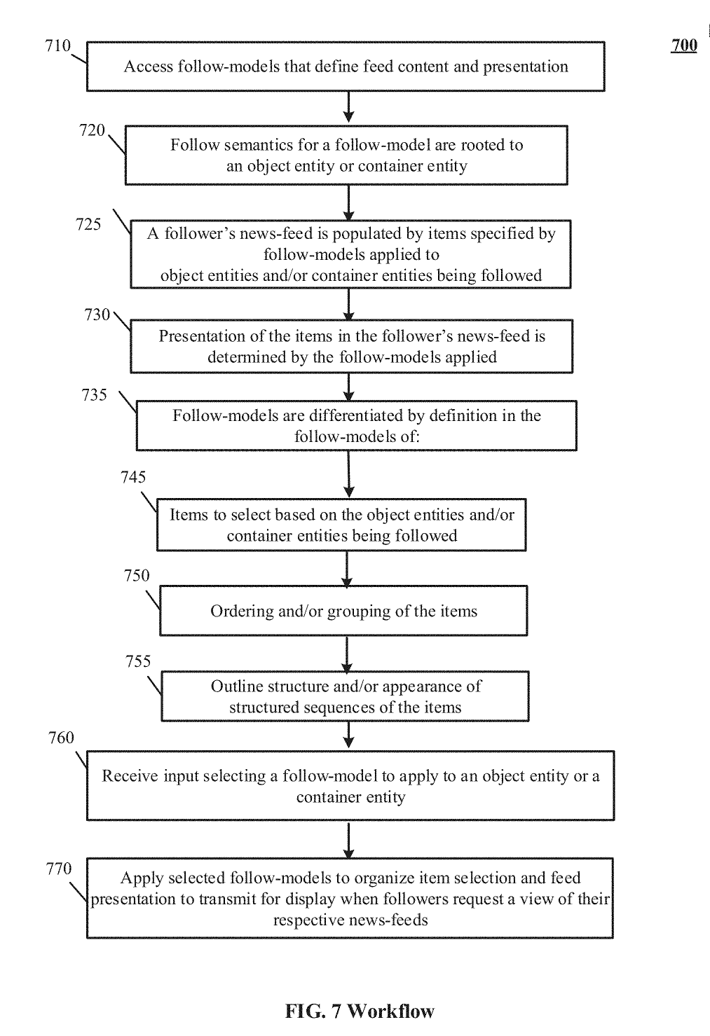

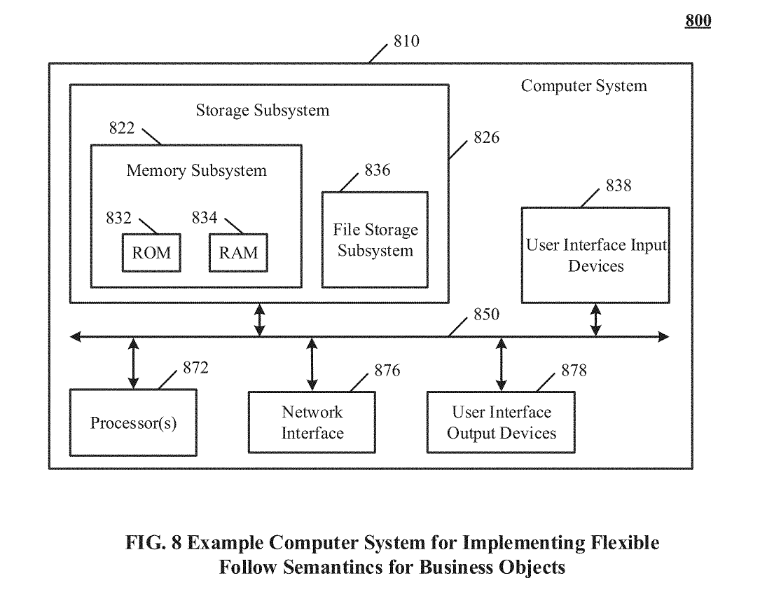

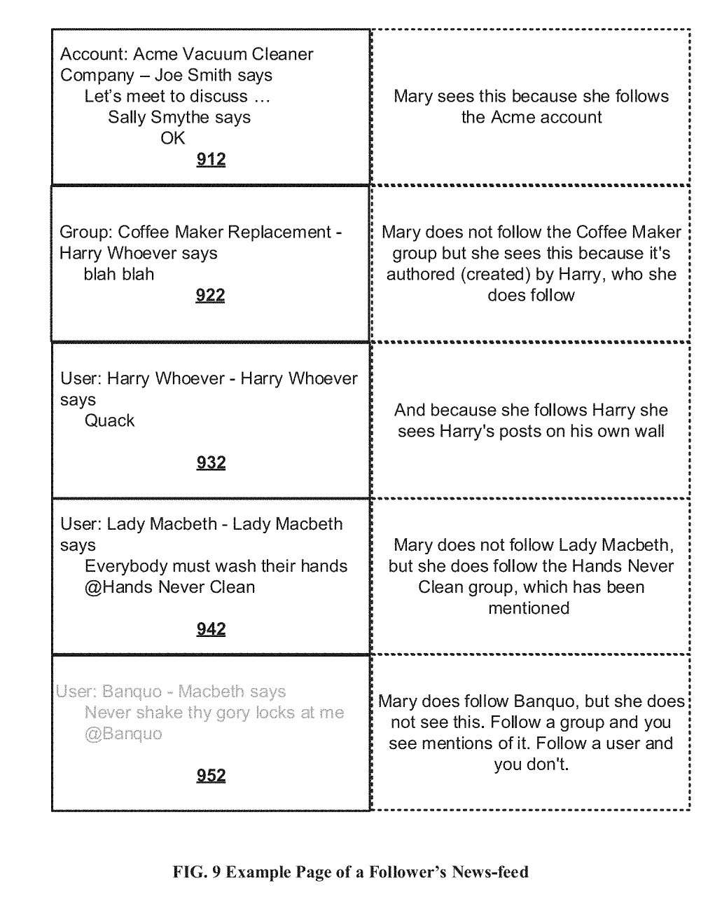

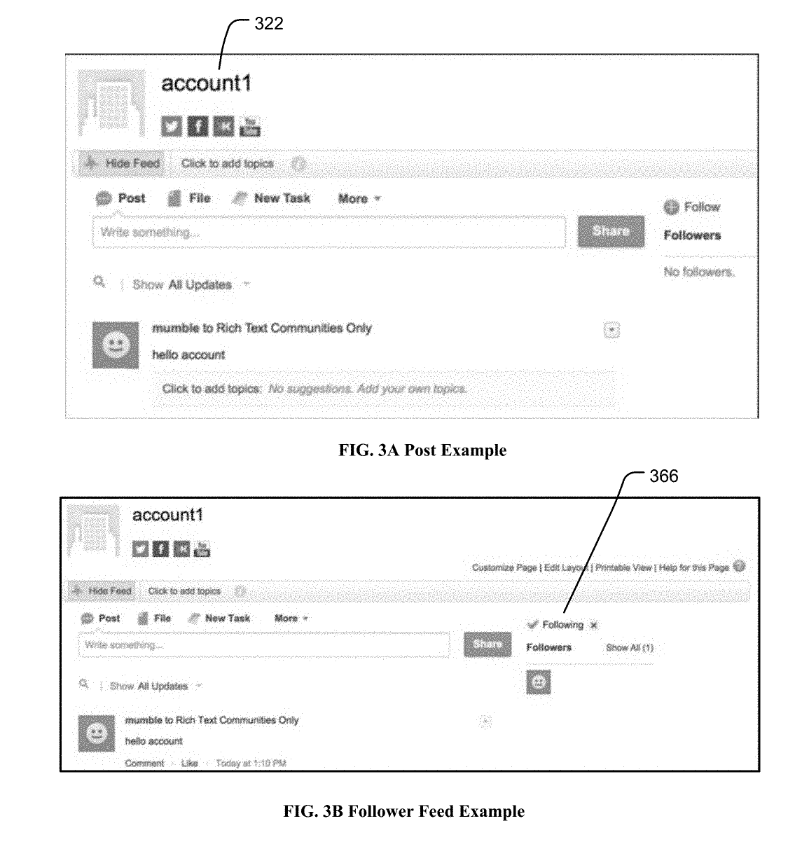

One example follow-model can include standard business object follow semantics for posting each conversation separately on the object's wall. For this follow-model, posts from the wall of the object (e.g. account, opportunity) are gathered into the follower's news-feed. FIG. 3A shows an example user interface for an account business object, with a “hello account” post by a user “mumble” to account1 business object 322. FIG. 3B shows the account business object UI for account1 with “mumble” as a follower 366. A news-feed is another example embodiment of this example follow-model.

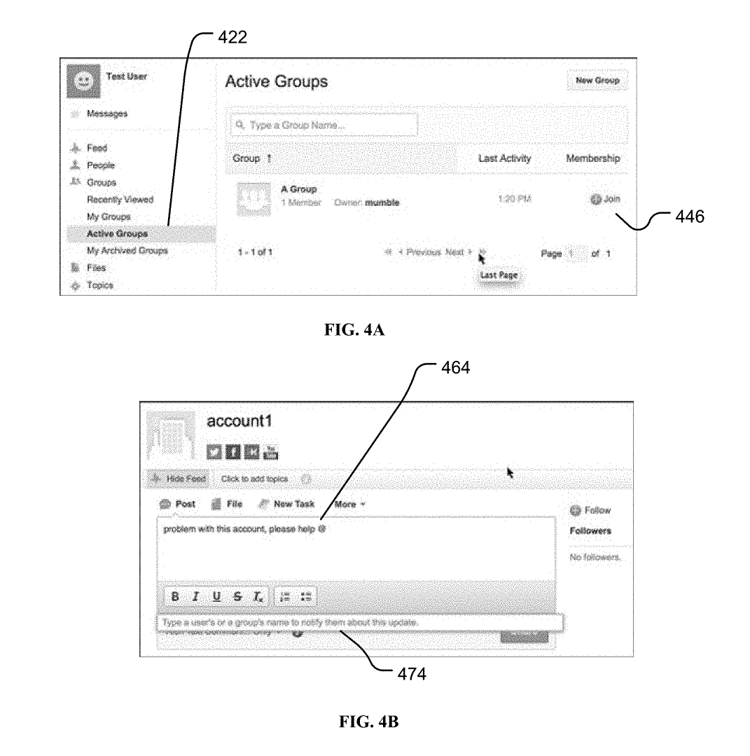

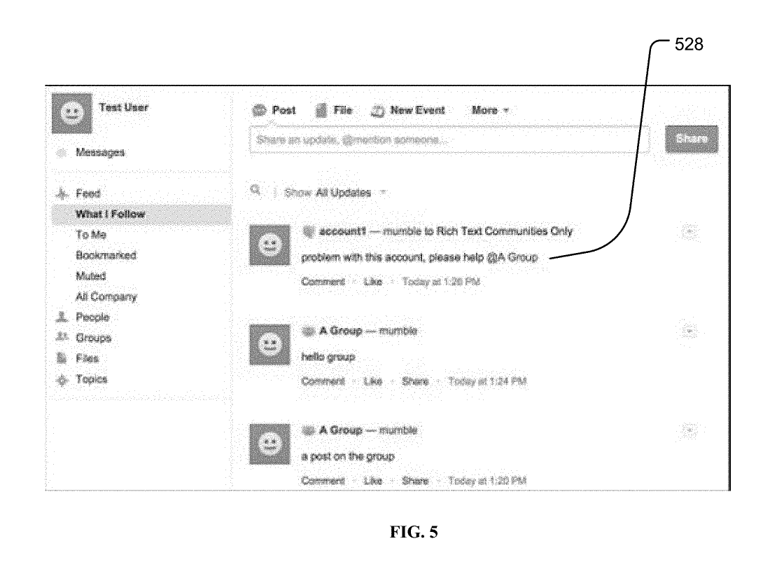

A group is a container in which conversations among users take place. For a second example follow-model for groups, the follow semantics specify following by group: posts from the group wall and posts from other places that contain mentions of the followed group are gathered into the follower's news-feed. FIG. 4A shows active groups 422, and a Join option 446 for “A Group”. Private groups can include a rule that specifies that only members can view updates. Users must ask to join private groups, and people and groups can be pulled into a group conversation using @mention. The prompt, “Type a user's or a group's name to notify them about this update” 474 appears when @ mention sign 464 has been entered. For users or groups added via the mention option, an update appears on the mentioned person's news feed, or on the group feed. That is, each time a comment is added to the thread for account1 in the example shown in FIG. 4B, an “update” feed-item appears in the feed of the mentionee and the mentionee also gains the ability to contribute a new response to the thread for account1. FIG. 5 shows one example in which a user will receive a feed-item 528 in their feed as a result of an @mention of a group in which they are a member, even for an account which they do not follow. Additionally, if a user has muted a given feed item and is subsequently mentioned explicitly in a comment appended to that feed time, the system will unmute it so that he will see the mention in his newsfeed.

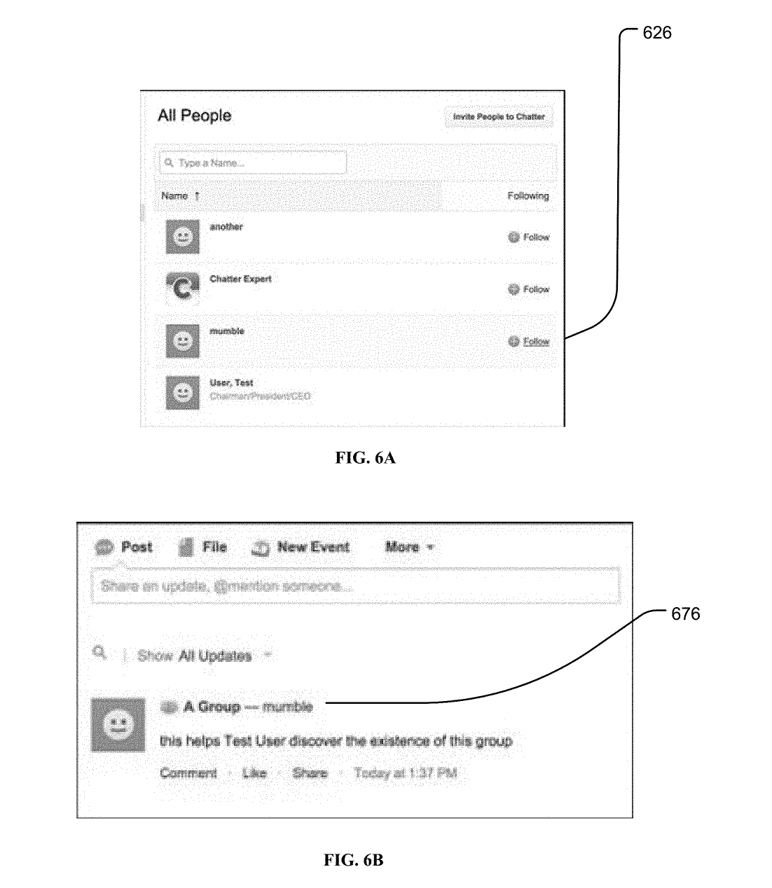

In a third example follow-model for users, the follow semantics include following a specific user: posts that the followed user “authors” are gathered and added to the follower's news-feed. FIG. 6A shows a UI for selecting Follow 626 for user “mumble”. When the user “mumble” posts, the follower receives the post in their newsfeed, even if the user posted in a business object or group which the follower does not follow. FIG. 6B shows an example posted by “mumble” to “A Group” 676. In some implementations of the user follow-model, access to feed-items may be controlled based on security or permissions. In one example of following a specific user, a new employee at a large company might “follow” the feed of their boss (a user) to learn where important conversations are taking place in the company.

In an example follow-model for a customer support case—a user-initiated support request—a follow-model can include a rule that specifies displaying feed-items as a single conversation, for the case business object. That is, each feed-item is not a separate post from the viewpoint of the requesting customer, who is considered to be an external user. Also, an external user may receive only feed-items addressed directly to them, while internal followers for the case receive the latest status of the customer and agent conversation as a series of threaded feed-items. In some implementations, communication can be archived by storing news-feeds associated with any external users.

In some implementations, a follow-model for a support case could include rules to cause the feed-items to be delivered as an outline or as a digest for which the follower receives email notification, and that subscribers could optionally include in their news-feed. For some follow-models, follow semantics can include gathering a rollup of recent posts on the object's wall into a single entry in the follower's news-feed. This rollup could be useful for a single conversation business object. In another follow-model, when a follower subscribes to some business objects, updates could arrive as emails and not appear as feed-items in a following news-feed. This follow-model could be particularly useful for a custom object called a bug which can be linked to cases to track product defects associated with customer support cases. For an internal follower who registers for any notification on a bug, the feed-items auto-follow them. An example follow-model for bugs could involve rolling up an object's latest status as of last update, into a follower's news-feed. Instead of interruptive inclusion of bug-related news-items, shown in the news-feed snippet below, a notice that the bug was updated could be added to the follower's news-feed.
User Sally: text A
   Bug: no it isn't
Group: Text B
User Michael: Text C
   Bug: yes it is
User Ted: Text D
Group: . . .
User . . .
Stuff . . .
   Bug: no it isn't

Instead of a conversational exchange intermixed with a lot of other content, without any context, the news-feed snippet shown below could be presented.
User Sally: text A
   Bug was updated; last status is: no it isn't
Group: Text B
User Michael: Text C
User Ted: Text D
Group: . . .
User . . .
Stuff . . .

An example subquery for producing the rollup version of a bug feed-item is shown below.
SELECT
/*+ORDERED USE_NL(f cgm s) INDEX(f PKFEEDS_ENTITY_HISTORY2) */
f.feeds_entity_history_id, subscriber_id,
f.parent_id, f.created_date, f.deleted, f.type,
f.last_update, f.network_id, f.clumping
FROM TABLE(CAST(iFeedItemIds AS ID_ARRAY)) t, core.feeds_entity_history2 f
WHERE f.organization_id=iOrganizationId
AND f.feeds_entity_history_id=t.column_value
AND f.parent_id LIKE KeyPrefixB.BUG ∥‘%’
AND bug.organization_id=iOrganizationId
AND bug.collaboration_group_id=f.parent_id
AND NOT EXISTS (
SELECT 1
/* if there are already other feed-items, or a clump related to this bug in the materialization */

In some implementations, a specific instance of a follow-model could include feed-items only received in the news feeds of explicitly @mentioned users, when a follow semantic for a custom business object includes that follow rule. In some implementations, multiple, configurable following feeds could be implemented for an enterprise social network, or other collaboration and communication application.

The developer of a custom object can choose its follow-model, so that instances of the custom business object use the chosen follow-model. That is, individual system developers can control which follow-model will be instantiated to customize functionality for their clients. In some implementations, tools for developing custom follow-models can be provided. The barrier to complete flexibility is performance, which limits complexity. Configuration can overwhelm value so implementations can be designed to be as automatic as possible.

In some implementations, a developer can auto-tag a record business object to a topic keyword that has been mentioned in the description field for that record, to ensure that anyone who follows that topic can see the record in their new-feed without the record creator needing to add the topic to the follower's news-feed manually. Auto-tagging can include the use of a hashtag, and can include adding a record to the FeedItem table for the record and adding the #topic to the body text.

### Partitioning

Partitioning happens when the feed-items are either fanned out to per-user materializations, or gathered to serve a request to compute the feed on the fly (i.e. unmaterialized). Subscriptions are bucketed by follow model so that the system knows the rules to follow when presenting feed items that are present as a consequence of a given subscription. When the system receives feed-items, they can be served to the people who are following (i.e. subscribing to the feed of a business object, group or user) and can be handled in the background.

In one implementation, partitioning engine 122 includes a procedure, shown below, that identifies the collection of entities for a given follower—partitioning existing subscriptions into four containers: all users, all non-user entities that are network aware (groups and records with network affinity), groups, and network-neutral entities (records). A separate container for groups facilitates the ability to provide feed results in response to a separate query for group mentions. Network neutral (agnostic) entities do not operate in an exclusive network environment or protocol. The container names in use by the procedure include UserIds, NetworkAwareEntityIds, GroupIds and NetworkAgnosticEntityIds.
PROCEDURE split_subscriptions_v2(
   iSubscribedIds IN ID_ARRAY,
   oUserIds OUT ID_ARRAY,
   oNetworkAwareEntityIds OUT ID_ARRAY,
   oGroupIds OUT ID_ARRAY,
   oNetworkAgnosticEntityIds OUT ID_ARRAY
   ) IS
BEGIN
   SELECT t.column_value
   BULK COLLECT INTO oUserIds
   FROM TABLE(CAST(iSubscribedIds AS ID_ARRAY)) t
   WHERE t.column_value LIKE KeyPrefixU.USERS ∥‘%’;
   SELECT t.column_value
   BULK COLLECT INTO oNetworkAwareEntityIds
   FROM TABLE(CAST(iSubscribedIds AS ID_ARRAY)) t
   WHERE t.column_value LIKE KeyPrefixC.COLLABORATION_GROUP ∥‘%’;
   OR t.column_value LIKE KeyPrefixT.TOPIC ∥‘%’;
   SELECT t.column_value
   BULK COLLECT INTO oGroupIds
   FROM TABLE(CAST(iSubscribedIds AS ID_ARRAY)) t
   WHERE t.column_value LIKE KeyPrefixC.COLLABORATION_GROUP ∥‘%’;
   SELECT t.column_value
   BULK COLLECT INTO oNetworkAgnosticEntityIds
   FROM TABLE(CAST(iSubscribedIds AS ID_ARRAY)) t
   WHERE t.column_value NOT LIKE KeyPrefixU.USERS ∥‘%’
   AND t.column_value NOT LIKE KeyPrefixC.COLLABORATION_GROUP ∥‘%’
   AND t.column_value NOT LIKE KeyPrefixT.TOPIC ∥‘%’;
END;

### Composition

The next phase of the process is composition. Composition engine 132 generates the news-feed for a follower—either by completing a set of subqueries that pull together a news-feed from various business objects, each governed by its corresponding follow-model; or by fanning feed-items out to per-subscriber collections (i.e. a materialized view of each subscriber's news-feed) as the feed-items are received in the enterprise system. The form of a query is shown below.
Select
   from feed
   where feed-item is by a user [or standard object, or group, or case]
Union
Select
   from feed, container 2 (standard object)
   where feed-item is parented by account
Union

Each user implicitly follows themselves as a parent (self-follow). That is, some entries in a user's news-feed are feed-items posted on their wall—the feed-item parent gets projected as the subscriber for feed-items parented by users, as shown in the select subquery listed below.
SELECT
*/+ORDERED USE NL(f s) INDEX(f PKFEEDS_ENTITY_HISTORY2) */
f.feeds_entity_history_id, f.parent_id subscriber_id, for a feed-item posted on (parented by)
a user, use parent id as subscriber id
f.parent_id, f.created_date, f.deleted, f.type,
f.last_update, f.network_id, f.clumping_status
FROM TABLE(CAST(iFeedItemIds AS ID_ARRAY)) t, core.feeds_entity_history2 f, core.feed_denorm_state s
WHERE f.organization_id=iOrganizationId
AND f.feeds_entity_history_id=t.column_value
AND f.parent_id LIKE KeyPrefixU.USERS ∥‘%’
. . .

The query listed below finds posts by users being followed. Access checks are not needed for subqueries for following users because access is assured. That is, if a follower has access to follow a user, then they can view that user's wall. The following subquery is an example subquery for identifying feed-items for users being followed.
UNION ALL
SELECT
/*+ORDERED USE_NL(f es s) INDEX(f PKFEEDS_ENTITY_HISTORY2) */
f.feeds_entity_history_id, es.subscriber_id,
f.parent_id, f.created_date, f.deleted, f.type,
f.last_update, es.network_id, f.clumping_status
FROM TABLE(CAST(iFeedItemsIds AS ID_ARRAY)) t, core.feeds_entity_history2 f, core.entity_subscription es, core.feed_denorm_state s
WHERE f.organization_id=iOrganizationId
AND f.feeds_entity_history_id=t.column_value
AND f.parent_id=f.created_by
/*-- if the post is not on the creator's wall, don't go any further */
AND f.type !=eFeedItemType.TRACKED_CHANGE
/* do not show tracked changes created by followed users */
AND es.organization_id=iOrganizationId
AND es.parent_id=f.created_by
/* the subscription follows the creating user */
AND es.network id=f.network_id
/* subscription on a user's wall is always in a specific network */

The following query example finds posts by followed users on public collaboration groups. In some implementations, write time access checks can be waived, as they are waived for posts on a creator's own wall. The subscription follows the creating user as a creator, and not as a parent.
UNION ALL
SELECT
/*+ORDERED USE_NL(f cg es s) INDEX(f PKFEEDS_ENTITY_HISTORY2) */
f.feeds_entity_history_id, es.subscriber_id,
f.parent_id, f.created_date, f.deleted, f.type,
f.last_update, es.network_id, f.clumping_status
FROM TABLE(CAST(iFeedItemIds AS ID_ARRAY)) t, core.feeds_entity_history2 f, core.collaboration_group cg, core.entity_subscription es, core.feed_denorm_state s
WHERE f.organization_id=iOrganizationId
AND f.feeds_entity_history_id=t.column_value
AND f.parent_id LIKE KeyPrefixC.COLLABORATION_GROUP ∥‘%’
/* post is on a collaboration group */
AND f.type !=eFeedItemType.TRACKED_CHANGE
/* do not show tracked changes created by followed users; if it is not a public group, do not evaluate further predicates; the probe can customarily be an EXISTS query, but due to the generation of a materialization of public groups, and a merge join we do it this way. */
AND cg.organization_=iOrganizationId
AND cg.collaboration_group_id=f.parent_id
AND cg.collaboration_type=eCollaborationGroupType.PUBLIC_ACCESS
AND es.organization_id=iOrganizationId
AND es.parent_id=f.created_by
AND es.network_id=f.network_id

The query example below includes posts to records being followed. Following a record may imply following across networks of which the follower is a member, and their groups, using group member as the subscriber ID. A group is followed in only one network, in the example shown below.
UNION ALL /*records being followed */
SELECT
/*+ORDERED USE NL(f es s) INDEX(f PKFEEDS_ENTITY_HISTORY2) */
f.feeds_entity_history_id, es. subscriber_id,
f.parent_id, f.created_date, f.deleted, f.type,
f.last_update, es.network_id, f.clumping_status
FROM TABLE(CAST(iFeedItemIds AS ID_ARRAY)) t, core.feeds_entity_history2 f, core.entity_subscription es, core.feed_denorm_state s
WHERE f.organization_id=iOrganizationId
AND f.parent_id NOT LIKE KeyPrefixU.USERS ∥‘%’
AND f.feeds_entity_history_id=t.column_value
AND es.organization_id=iOrganizationId
AND es.parent_id=f.parent_id
/* following a record means following posts on the record's wall */
AND (es.network_id=f.network_id OR f.network_id=eNetworkScope.ALL NETWORKS)
UNION ALL
SELECT
/*+ ORDERED USE NL(f cgm s) INDEX(f PKFEEDS ENTITY HISTORY2) */
f.feeds_entity_history_id, cgm.ug_id subscriber_id,
f.parent_id, f.created_date, f.deleted, f.type,
f.last_update, f.network_id, f.clumping_status
FROM TABLE(CAST(iFeedItemIds AS ID_ARRAY)) t, core.feeds_entity_history2 f, core.collaboration_group_member cgm, core.feed_denorm_state s
WHERE f.organization_id=iOrganizationId
AND f.feeds_entity_history_id=t.column_value
AND f.parent_id LIKE KeyPrefixC.COLLABORATION_GROUP ∥‘%’
AND cgm.organization_id=iOrganizationId
AND cgm.collaboration_group_id=f.parent_id
. . .

The query example snippet shown below includes feed cross references to the groups to which the follower is a member, plus @mentions of the groups to which they are a member.
UNION
SELECT /*+ORDERED USE_NL(f m cgm s) INDEX(f
PKFEEDS_ENTITY_HISTORY2) INDEX(m IEFEED_MENTION_FEH) INDEX(cgm AKCOLLABORATION_GRP_MEMBER_GRP) */
m.feeds_entity_history_id, cgm.ug_id subscriber_id,
m.parent_id, m.feed_created_date created_date, f.deleted, f.type,
m.feed_last_update last update, m.network_id, f.clumping_status
FROM TABLE(CAST(iFeedItemIds AS ID_ARRAY)) t, core.feeds_entity_history2 f, core.feed_mention m, core.collaboration_group_member cgm, core.feed_denorm_state s
WHERE f.organization_id=iOrganizationId
AND f.feeds_entity_history_id=t.column_value
AND m.organization_id=iOrganizationId
AND m.feeds_entity_history_id=t.column_value
AND m.mention_type IN (eFeedCrossReferenceType.CROSS_REF_TO_FOLLOWERS, eFeedCrossReferenceType.MENTION)
AND m.subject_id LIKE KeyPrefixC.COLLABORATION_GROUP ∥‘%’
AND m.deleted=‘0’
AND cgm.organization_id=iOrganizationId
AND cgm.collaboration_group_id=m.subject_id

The set of subqueries listed above can be used to build a materialized view of the news-feed for each follower, including feed-items that do not need access checks. In some implementations, another phase of fanout can perform access checks for feed-items on entities that need them. For example, access checking would be needed for feed-items that a follower would see not because they followed the parent, but because they followed the user who was the feed-item author.

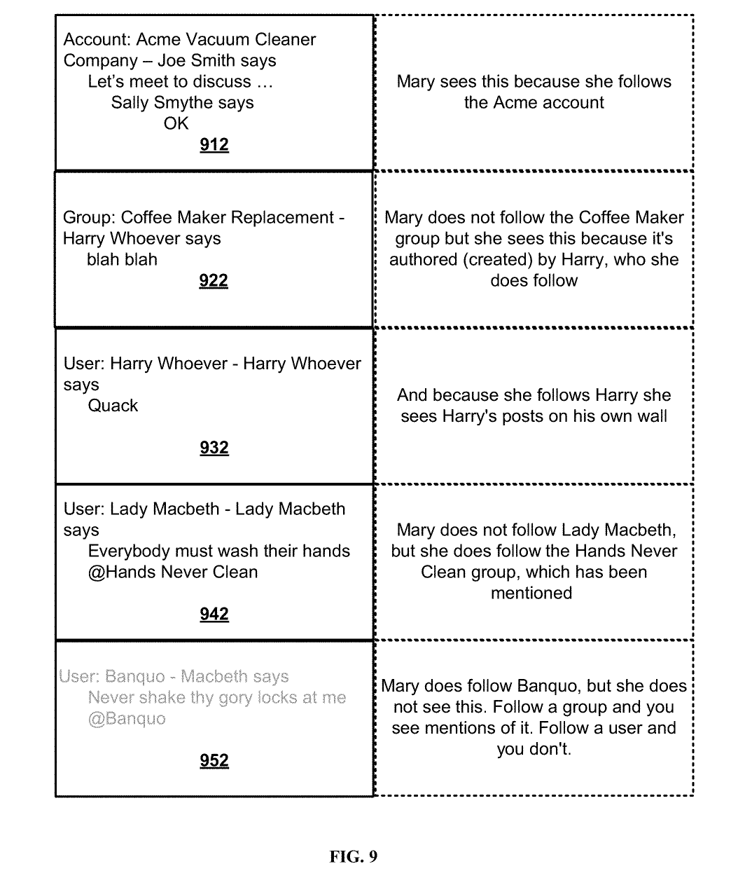

An example page of a follower's news-feed is shown in FIG. 9. The follower, Mary, sees the Acme account posts 912 because she follows the Acme account. She does do not follow the Coffee Maker Replacement group, but sees that post 922 because the feed-item was authored (created) by Harry, who she does follow. Because she follows Harry, Mary sees Harry's posts to his own wall 932. Even though Mary does not follow Lady Macbeth, she does follow the Hands Never Clean group, which has been @mentioned, so Mary sees Lady Macbeth's post 942. Then, user Macbeth posts on Banquo's wall. Mary does not see this post even though she follows Banquo. She doesn't see posts addressed (either by mention or wall post) to people she does follow, when the posts are authored by people she does not follow. To see this post, “Never shake thy gory locks at me,” Mary would need to follow the author, Macbeth.

An example workflow for generating flexible follow semantics for business objects using follow-models designed to optimize news-feeds for relevance and usefulness, in a multi-tenant environment is described below.

### Flexible Follow Semantics Workflow

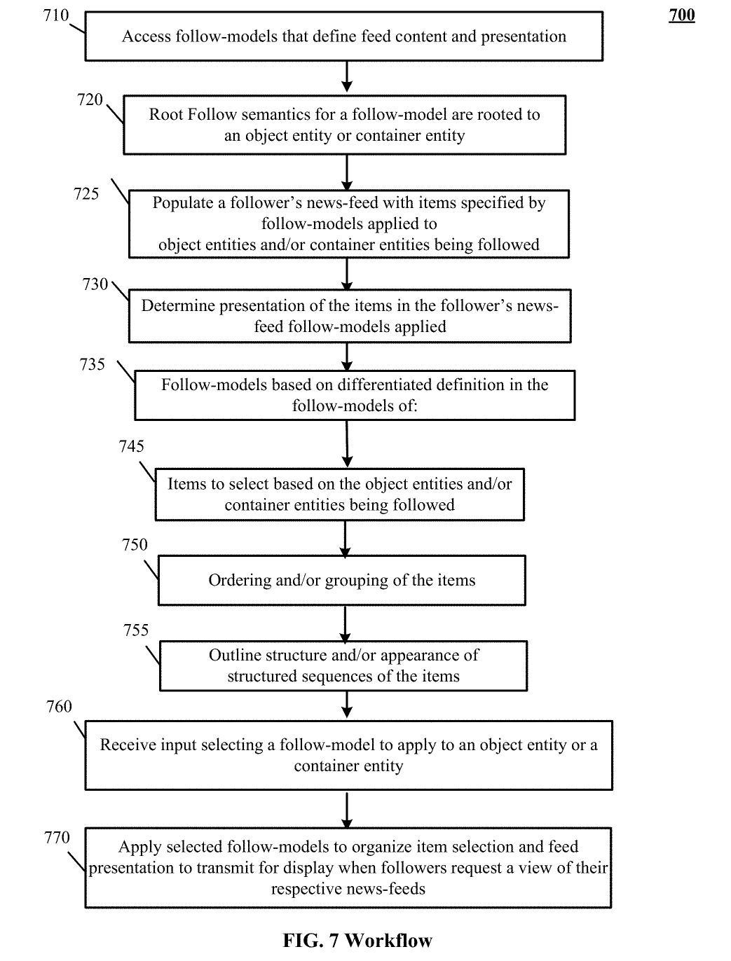

FIG. 7 shows an example workflow 700 of one implementation of generating flexible follow semantics for business objects in an enterprise social network. Workflow 700 can be implemented at least partially with a database system, e.g., by one or more processors configured to receive or retrieve information, process the information, store results, and transmit the results. Other implementations may perform the steps in different orders and/or with different, fewer or additional steps than the ones illustrated in FIG. 5. Multiple steps can be combined in some implementations.

At action 710, access follow-models that define feed content and presentation. Follow-models are described further in 720, 725, and 730. At 720, follow semantics for a follow-model are rooted to an object entity or to a container. At 725, a follower's news-feed is populated by feed-items specified by follow-models applied to object entities and/or container entities being followed. Examples of object entities can include accounts and opportunities in an enterprise social network. An example of a container entity is a group, described supra.

At 730, presentation of the items in the follower's news-feed is determined by the follow-model applied. At 735, follow-models are differentiated by the definition in the following-models, described further in 745, 750 and 755. Descriptions include, at 745, items to select based on the object entities and/or container entities being followed; at 750, ordering and/or grouping of the items; and at 755, outline structure and/or appearance of structured sequences of the items.

At action 760, input selecting a follow-model to apply to an object entity or to a container entity is received.

Action 770 includes applying selected follow-models to organize item selection and feed-item presentation to transmit for display when followers request a view of their respective news-feeds.

### Computer System

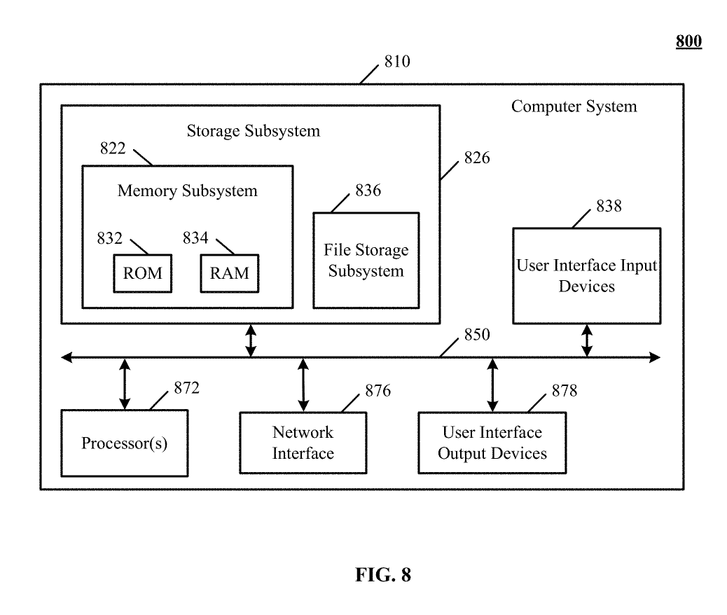

FIG. 8 is a block diagram of an example computer system 800 for implementing flexible follow semantics for business objects. FIG. 8 is a block diagram of an example computer system, according to one implementation. The processor can be an ASIC or RISC processor. It can be an FPGA or other logic or gate array. It can include graphic processing unit (GPU) resources. Computer system 810 typically includes at least one processor 872 that communicates with a number of peripheral devices via bus subsystem 850. These peripheral devices may include a storage subsystem 824 including, for example, memory devices and a file storage subsystem, user interface input devices 838, user interface output devices 876, and a network interface subsystem 874. The input and output devices allow user interaction with computer system 810. Network interface subsystem 874 provides an interface to outside networks, including an interface to corresponding interface devices in other computer systems.

User interface input devices 838 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include the possible types of devices and ways to input information into computer system 810.

User interface output devices 876 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide a non-visual display such as audio output devices. In general, use of the term “output device” is intended to include the possible types of devices and ways to output information from computer system 810 to the user or to another machine or computer system.

Storage subsystem 824 stores programming and data constructs that provide the functionality of some or all of the methods described herein. This software is generally executed by processor 872 alone or in combination with other processors.

Memory 822 used in the storage subsystem can include a number of memories including a main random access memory (RAM) 834 for storage of instructions and data during program execution and a read only memory (ROM) 832 in which fixed instructions are stored. A file storage subsystem 836 can provide persistent storage for program and data files, and may include a hard disk drive, a floppy disk drive along with associated removable media, a CD-ROM drive, an optical drive, or removable media cartridges. The software used to implement the functionality of certain systems may be stored by file storage subsystem 836 in the storage subsystem 824, or in other machines accessible by the processor.

Bus subsystem 850 provides a mechanism for letting the various components and subsystems of computer system 810 communicate with each other as intended. Although bus subsystem 850 is shown schematically as a single bus, alternative implementations of the bus subsystem may use multiple busses.

Computer system 810 can be of varying types including a workstation, server, computing cluster, blade server, server farm, or any other data processing system or computing device. Due to the ever-changing nature of computers and networks, the description of computer system 810 depicted in FIG. 8 is intended only as one example. Many other configurations of computer system 810 are possible having more or fewer components than the computer system depicted in FIG. 8.

### Particular Implementations

In one implementation, a method of creating sensible news-feeds that present relevant and useful feed-items to followers, includes accessing a plurality of follow-models that define feed content and presentation. For this method, follow semantics for a follow-model are rooted to an object entity or a container entity; a follower's news-feed is populated by items specified by follow-models applied to object entities and/or container entities being followed; and presentation of the items in the follower's news-feed is determined by the follow-models applied. For the method, the follow-models are differentiated by definition in the follow-models of items to select based on the object entities and/or container entities being followed, ordering and/or grouping of the items, and outline structure and/or appearance of structured sequences of the items. The method also includes receiving input, from a developer of an object entity or a container entity, selecting a follow-model to apply to an object entity or container entity being followed. The method further includes applying the selected follow-models to organize item selection and feed presentation to transmit for display when followers request a view of their respective news-feeds.

In some implementations, a method of creating news-feeds that present useful and relevant feed-items to followers includes follow-models that define item visibility in the presentation, wherein ordering of sections of a presentation influences whether the item is above a fold and immediately visible or below the fold where it becomes visible by scrolling. This method can further include providing an interface to the follower that allows the follower to determine ordering of sections of the follower's news-feed.

Some implementations of the method also include the follow-models defining item visibility in the presentation, wherein one or more summary items defined by a support case follow-model precede message exchange items. For some implementations, the method further includes the support case follow-model further defining broader visibility, of support staff internal communication items, to the support staff than to an external user who opened the support case. The support case follow-model can further define annotations to and/or comments on communication items, from an external user who opened the support case, that are visible to support staff and not to the external user.

In other implementations, the follow-models include defining whether a follower will have an option to mute items related to an object entity or container entity being followed, thereby causing items selected for a muted entity being followed to not be displayed until muting is discontinued. The method can also include unmuting a follower's feed for an object entity or container entity being followed when an object arrives that identifies the follower in an @mention tag.

In some implementations, the method of creating sensible news-feeds that present relevant and useful feed-items to followers is enhanced by receiving instructions to edit a feed-model, and updating the feed-model according to the instructions.

Other implementations may include a computer implemented device or system to perform any of the methods described above, the device or system including at least one processor, and memory coupled to the processor, the memory holding follow-model definition data structures and computer instructions loaded into the memory, implementing applying a plurality of the follow-models to define feed content and presentation in a follower's news-feed.

Yet another implementation may include a tangible computer readable storage medium including computer program instructions that cause a computer to implement any of the methods described above. The tangible computer readable storage medium does not include transitory signals.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

What is claimed is:

1. A method including:
accessing a plurality of follow-models that define feed content and presentation;
wherein
follow semantics for a follow-model are rooted to an object entity or a container entity;
a follower's news-feed is populated by items specified by follow-models applied to object entities and/or container entities being followed;
presentation of the items in the follower's news-feed is determined by the follow-models applied;
the follow-models are differentiated by definition in the follow-models of:
items to select based on the object entities and/or container entities being followed;
ordering and/or grouping of the items;
outline structure and/or appearance of structured sequences of the items;
receiving input selecting a follow-model to apply to an object entity or container entity being followed; and
applying the selected follow-models to organize item selection and feed presentation to transmit for display when followers request a view of their respective news-feeds.

2. The method of claim 1, further including:
the follow-models defining item visibility in the presentation, wherein ordering of sections of a presentation influences whether the item is above a fold and immediately visible or below the fold where it becomes visible by scrolling.

3. The method of claim 2, further including providing an interface to the follower that allows the follower to determine ordering of sections of the follower's news-feed.

4. The method of claim 1, further including:
the follow-models defining item visibility in the presentation, wherein one or more summary items defined by a support case follow-model precede message exchange items.

5. The method of claim 4, wherein:
the support case follow-model further defines broader visibility, of support staff internal communication items, to the support staff than to an external user who opened the support case.

6. The method of claim 4, wherein:
the support case follow-model further defines annotations to and/or comments on communication items, from an external user who opened the support case, that are visible to support staff and not to the external user.

7. The method of claim 1, further including:
the follow-models defining whether a follower will have an option to mute items related to an object entity or container entity being followed, thereby causing items selected for a muted entity being followed to not be displayed until muting is discontinued.

8. The method of claim 7, further including:
unmuting a follower's feed for an object entity or container entity being followed when an object arrives that identifies the follower in an @mention tag.

9. The method of claim 1, further including receiving instructions to edit a feed-model and updating the feed-model according to the instructions.

10. A device, including:
at least one processor and memory coupled to the processor, the memory holding follow-model definition data structures and computer instructions implementing applying a plurality of the follow-models to define feed content and presentation in a follower's news-feed;
wherein
follow semantics for the follow-model are rooted to an object entity or container entity;
the follower's news-feed is populated by items specified by follow-models applied to object entities and/or container entities being followed;
presentation of the items in the follower's news-feed is determined by the follow-models applied;
the follow-models definition data structures are differentiated by definition of:
items to select based on the object entities and/or container entities being followed;
ordering and/or grouping of the items;
outline structure and/or appearance of structured sequences of the items;
the computer instructions further implementing:
receiving input selecting a follow-model to apply to an object entity or container entity being followed; and
applying the selected follow-models to organize item selection and feed presentation for display when followers request a view of their respective news-feeds.

11. The device of claim 10, further including:
the follow-models defining item visibility in the presentation, wherein ordering of sections of a presentation influences whether the item is above a fold and immediately visible or below the fold where it becomes visible by scrolling.

12. The device of claim 11, further including providing an interface to the follower that allows the follower to determine ordering of sections of the follower's news-feed.

13. The device of claim 10, further including:
the follow-models defining item visibility in the presentation, wherein one or more summary items defined by a support case follow-model precede message exchange items.

14. The device of claim 13, wherein:
the support case follow-model further defines broader visibility, of support staff internal communication items, to the support staff than to an external user who opened the support case.

15. The device of claim 13, wherein:
the support case follow-model further defines annotations to and/or comments on communication items, from an external user who opened the support case, that are visible to support staff and not to the external user.

16. The device of claim 10, further including:
the follow-models defining whether a follower will have an option to mute items related to an object entity or container entity being followed, thereby causing items selected for a muted entity being followed to not be displayed until muting is discontinued.

17. The device of claim 16, further including:
unmuting a follower's feed for an object entity or container entity being followed when an object arrives that identifies the follower in an @mention tag.

18. A computer readable storage medium including:
memory holding follow-model definition data structures and computer instructions that, when executed on a processor, implement application of a plurality of the follow-models to define feed content and presentation in a follower's news-feed;
wherein
follow semantics for the follow-model are rooted to an object entity or container entity;
the follower's news-feed is populated by items specified by follow-models applied to object entities and/or container entities being followed;
presentation of the items in the follower's news-feed is determined by the follow-models applied;
the follow-models definition data structures are differentiated by definition of:
items to select based on the object entities and/or container entities being followed;
ordering and/or grouping of the items;
outline structure and/or appearance of structured sequences of the items;
the computer instructions further implement:
receiving input selecting a follow-model to apply to an object entity or container entity being followed; and
applying the selected follow-models to organize item selection and feed presentation for display when followers request a view of their respective news-feeds.

19. The computer readable storage medium of claim 18, further including:
the follow-models defining item visibility in the presentation, wherein ordering of sections of a presentation influences whether the item is above a fold and immediately visible or below the fold where it becomes visible by scrolling.

20. The computer readable storage medium of claim 19, further including providing an interface to the follower that allows the follower to determine ordering of sections of the follower's news-feed.

21. The computer readable storage medium of claim 18, further including:
the follow-models defining item visibility in the presentation, wherein one or more summary items defined by a support case follow-model precede message exchange items.

22. The computer readable storage medium of claim 21, wherein:
the support case follow-model further defines broader visibility, of support staff internal communication items, to the support staff than to an external user who opened the support case.

23. The computer readable storage medium of claim 21, wherein:
the support case follow-model further defines annotations to and/or comments on communication items, from an external user who opened the support case, that are visible to support staff and not to the external user.

24. The computer readable storage medium of claim 18, further including:
the follow-models defining whether a follower will have an option to mute items related to an object entity or container entity being followed, thereby causing items selected for a muted entity being followed to not be displayed until muting is discontinued.

25. The computer readable storage medium of claim 24, further including:
unmuting a follower's feed for an object entity or container entity being followed when an object arrives that identifies the follower in an @mention tag.
